(19) United States
(12) Patent Application Publication
(10) Pub. No.: US 2014/0166823 A1
(43) Pub. Date: Jun. 19, 2014

(54) CABLE CLAMP

(71) Applicants: HONG FU JIN PRECISION INDUSTRY (ShenZhen) CO., LTD., (US); HON HAI PRECISION INDUSTRY CO., LTD., New Taipei (TW)

(72) Inventor: XIAN-XIU TANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/725,787

(22) Filed: Dec. 21, 2012

(30) Foreign Application Priority Data
Dec. 13, 2012 (CN) 201210536888.1

(51) Int. Cl. F16L 3/10

(52) U.S. Cl. CPC F16L 3/10
USPC 248/49

(57) ABSTRACT

A cable clamp includes a clamping member for clamping cables and a space-infilling board mounted to the clamping member. The board includes a number of detachable portions to provide adjustability of the overall size of the board, and to allow for the creation of additional cable slots if any are required.

### BACKGROUND

1. Technical Field

The present disclosure relates to a cable clamp.

2. Description of Related Art

Cable clamps may be mounted in a chassis between a sidewall of the chassis and a motherboard mounted in the chassis, to clamp cables. As a result, the cables and the cable clamps may prevent airflow from passing through a space between the motherboard and the sidewall of the chassis. However, where the space between the sidewall and the motherboard is large, airflow still may pass through the space beside the cable clamps.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a cable clamp.

FIGS. 2 and 3 show different using states of the cable clamp of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

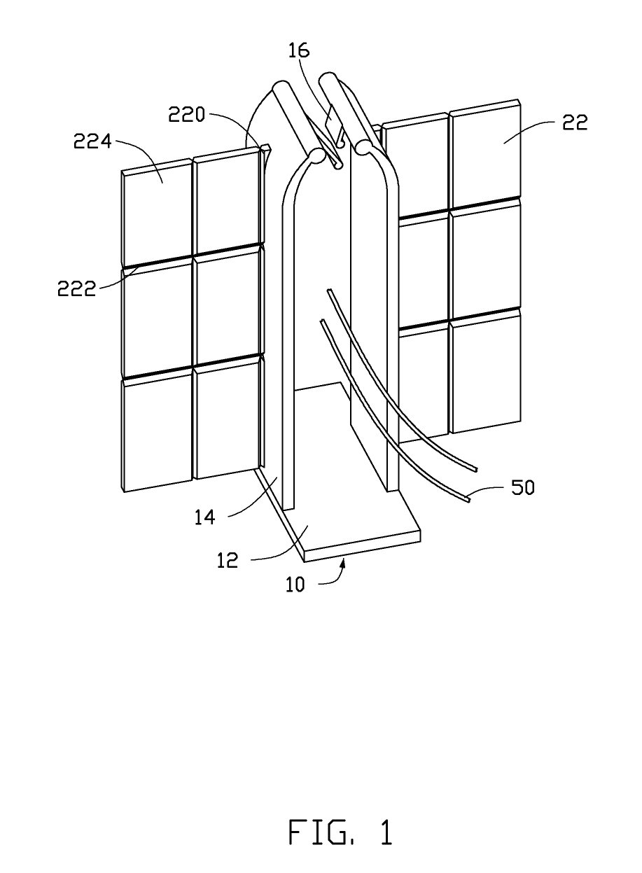

Referring to FIG. 1, an exemplary embodiment of a cable clamp includes a clamping member 10 for clamping cables 50, and two boards 22 for preventing airflow from passing around the sides of the clamping member 10.

The clamping member 10 includes a base 12, two arms 14 perpendicularly extending up from opposite sides of a top of the base 12, and two pins 16 extending from top ends of the arms 14 opposite to the base 12 and slantingly extending toward each other. A bottom of the base 12 is coated with glue.

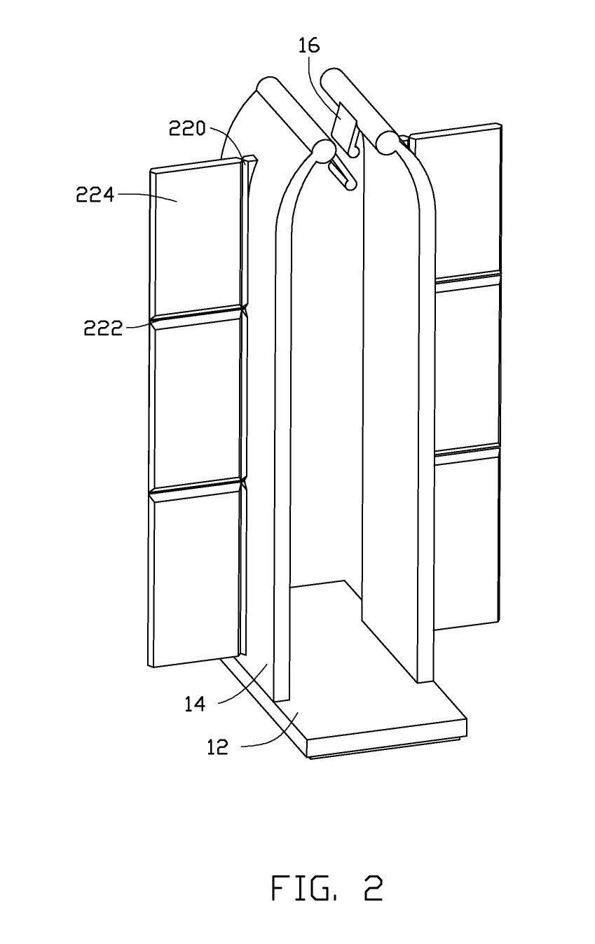

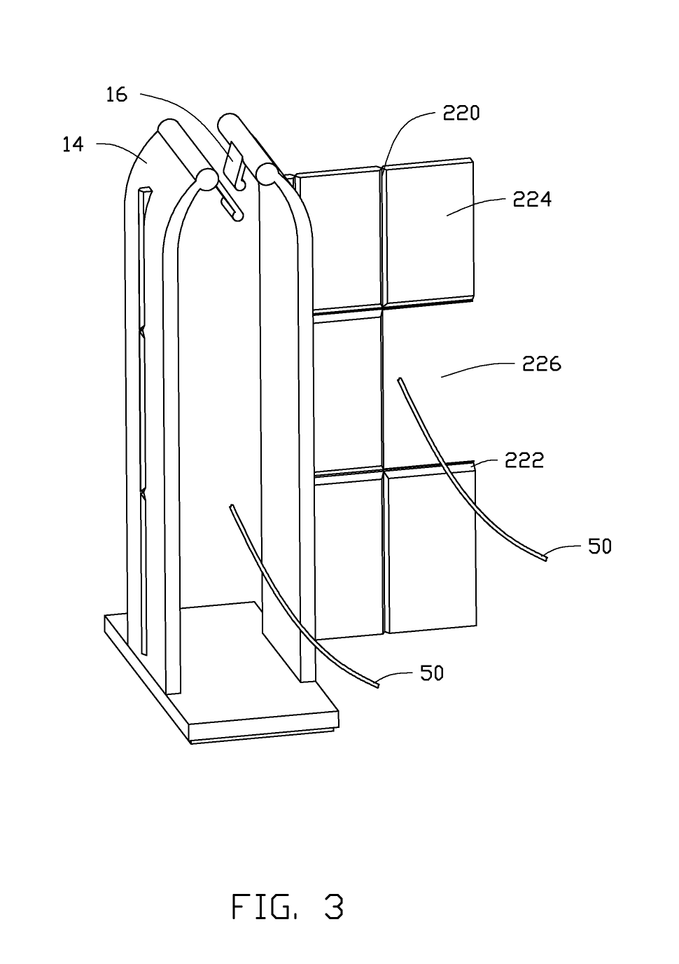

The boards 22 are integrally formed at outer sides of the arms 14. Opposite sides of each board 22 each define two lengthways first slots 220 along a direction perpendicular to the base 12 in a center of the board 22 and a junction between the board 22 and an arm 14. Two transverse second slots 222 are defined in each side of each board 22 and perpendicularly intersecting with the first slots 220. Therefore, each board 22 is divided into six portions 224. The boards 22 or some of the portions 224 can easily be removed along the first and second slots 220 and 222, to adapt the profile and size of the cable clamp to fit a space in a chassis (not shown) for receiving the cable clamp. FIG. 2 shows six portions 224 removed. FIG. 3 shows one of the boards 22 removed and one of the portions 224 removed. In case the sectional volume or size of the cables 50 is too great to be clamped completely within the arms 14, some of the portions 224 can be removed to effectively create a slot 226 in the board 22 to receive the surplus of cables 50.

In another embodiment, each board 22 can define a greater number of first and second slots 220 and 222. Therefore, each board 22 can be divided into a greater number of portions 224.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A cable clamp, comprising:
a clamping member to clamp cables; and
a board mounted to the clamping member, wherein the board comprises a plurality of detachable portions.

2. The cable clamp of claim 1, wherein the board defines a plurality of lengthways first slots and a plurality of transverse second slots intersecting with the first slots in opposite sides of the board, to divide the board into the plurality of portions.

3. The cable clamp of claim 1, wherein the clamping member comprises a base and two arms extending up from a top of the base to clamp the cables.

4. The cable clamp of claim 3, wherein the clamping member further comprises two pins extending from upper portions of the arms toward each other.

5. The cable clamp of claim 3, wherein a bottom of the base opposite to the arms is coated with glue.

6. The cable clamp of claim 3, wherein the board is connected to an outer surface of one of the arms opposite to the other arm, one of the plurality of first slots is defined in a junction between the arm and the board and perpendicular to the base, and the plurality of second slots perpendicularly intersect with the first slot.

7. The cable clamp of claim 1, wherein the board defines a slot in response to one of the plurality of portions being removed, to receive some of the cables.
